(19) United States
(12) Patent Application Publication
(10) Pub. No.: US 2009/0019688 A1
(43) Pub. Date: Jan. 22, 2009

(54) APPARATUS AND METHOD FOR SECURING PEWS

(76) Inventor: Marc Samuel Zweben, Potomac, MD (US)

Correspondence Address: WEISS & MOY PC, 4204 NORTH BROWN AVENUE, SCOTTSDALE, AZ, 85251, US

(21) Appl. No.: 11/778,491

(22) Filed: Jul. 16, 2007

(51) Int. Cl. B23P 19/04; A47C 15/00

(52) U.S. Cl. 29/700; 297/232

(57) ABSTRACT

A pew securing apparatus and method features a base having a plurality of barbs extended at an angle therefrom, with the base being secured to the underside of a leg of a pew. The weight of the pew causes the barbs to penetrate a carpeted surface. The combination of the weight of the pew and the angle of the barbs causes the pew to resist lateral movement when in position. In one embodiment, two (or more) apparatuses may be utilized, and it may be desired to position one so that the plurality of barbs extend in a first direction, and a second so that its plurality of barbs extend in a second, different direction.

### FIELD OF THE INVENTION

The present invention relates generally to apparatuses and methods for securing items of furniture in position and, more particularly, to an apparatus and method for securing pews in position on a carpeted surface.

### BACKGROUND OF THE INVENTION

Pews are bench-type seating apparatuses that are commonly associated with churches, temples, and other houses of worship. Typically, they are elongated and heavy. Some pews have individual seats delineated thereon with armrests or the like—others comprise a single, continuous seating surface.

It is often the case that pews are located in a building which has a carpeted floor surface. It is generally desired to secure pews in position, so as to maintain them in a desired arrangement and orientation. A typical prior art method for doing so consists of securing a metal angle to a side of a pew with a wood screw, and then attaching the angle to the concrete substrate, through the carpeted surface, with a screw inserted into a metal or plastic anchor located in the concrete substrate.

There are a number of drawbacks associated with the prior art method of securing pews in position on a carpeted surface. These include that the prior art method is relatively labor-intensive and requires the creation of holes in the underlying carpet and floor surface. It also prevents the purposeful movement of pews, whether for purposes of creating a new seating arrangement, clearing a space for a special event, replacing carpeting, or otherwise, without first disengaging the metal angle from the floor and/or the pew.

A need exists for an apparatus and method for securing pews in position on a carpeted surface that does not require the damaging of the underlying carpeting and flooring, and that permits ready relocation of a pew without the need for disengagement of a securing apparatus. The present invention satisfies these needs and provides other, related, advantages.

### SUMMARY OF THE INVENTION

In accordance with one embodiment of the present invention, a method for securing a pew to a carpeted surface is disclosed. The method comprises: positioning at least one pew securing apparatus to an underside of at least one leg of a pew; the pew securing apparatus comprising: a base; a plurality of barbs extending at an angle from the base; and at least one opening through the base; and lowering the pew onto a carpeted surface until the plurality of barbs penetrate the carpeted surface.

In accordance with another embodiment of the present invention, a method for securing a pew to a carpeted surface is disclosed. The method comprises: positioning a first pew securing apparatus to an underside of at least one leg of a pew; the first pew securing apparatus comprising: a base; a plurality of barbs extending at an angle from the base; and at least one opening through the base; wherein the first pew securing apparatus is secured so that the plurality of barbs extend in a first direction; positioning a second pew securing apparatus to an underside of at least one leg of a pew; the second pew securing apparatus comprising: a base; a plurality of barbs extending at an angle from the base; and at least one opening through the base; and wherein the second pew securing apparatus is secured so that the plurality of barbs extend in a second direction that is different from the first direction; lowering the pew onto a carpeted surface until each of the plurality of barbs on the first pew securing apparatus and the plurality of barbs on the second pew securing apparatus penetrate the carpeted surface.

In accordance with a further embodiment of the present invention, a pew securing apparatus is disclosed. The apparatus comprises, in combination: a base coupled to an underside of a pew; and a plurality of barbs extending at an angle from the base.

### BRIEF DESCRIPTION OF THE DRAWINGS

FIG. 1 is a top view of a pew securing apparatus consistent with an embodiment of the present invention.

FIG. 2 is a side view of the apparatus of FIG. 1.

FIG. 3 is a side view illustrating two pew securing apparatuses in position on the underside of a pew.

### DETAILED DESCRIPTION OF THE PREFERRED EMBODIMENTS

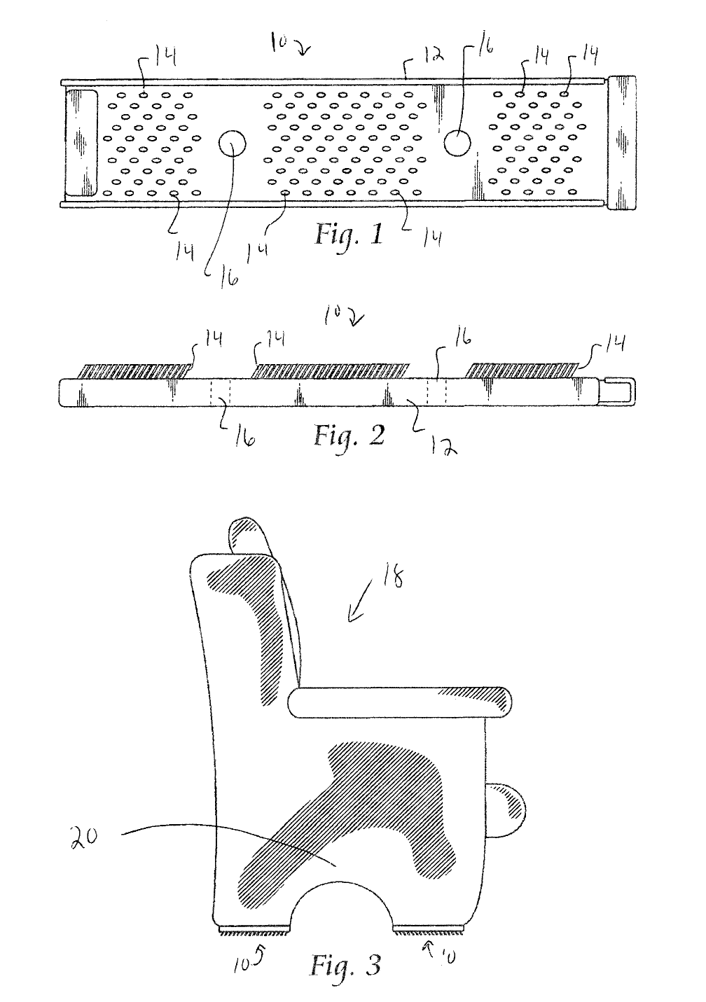

Referring first to FIGS. 1-2, a pew securing apparatus 10 is shown. The apparatus 10 preferably comprises a base 12, a plurality of barbs 14 extending at an angle from the base 12, and at least one opening 16 through the base 12.

It should be noted that a pew securing apparatus 10 may be provided by utilizing a nap grip insert, of a type that is used with a carpet installation tool called a “knee kicker.” It may be possible to utilize a nap grip insert in a substantially unmodified form, or it may be desired to modify it in one or more ways, for example by adding one or more additional openings 16, by changing the length of the base 12, and/or by providing on the same base a plurality of barbs 14 oriented in a first direction and a plurality of barbs 14 oriented in a second direction.

A typical pew 18 is visible in FIG. 3. A pew 18 typically has at least two legs 20 (only one of which is shown in FIG. 3). A pew securing apparatus 10 may be secured to the underside of a leg 20 by the insertion of a screw (not shown) through each opening 16, and into the leg 20.

As shown in FIG. 3, in one embodiment, two pew securing apparatuses 10 may be secured to the underside of a single leg 20. In one embodiment, a first pew securing apparatus 10 is secured to the underside of a leg 20 with the barbs 14 extending in a first direction, and a second pew securing apparatus 10 is secured to the underside of the same leg 20 with the barbs 14 extending in a second direction. In this orientation, the pew 18 will be particularly resistant to unintended movement.

After an appropriate location is selected for position of the pew 18, and after the securing of a desired number of securing apparatuses 10 to one or more of the legs 20 thereof, the pew 18 is ready to be secured to an underlying carpeted surface. To accomplish this, the pew is lifted over the selected location, and is then allowed to come to rest on the carpeted surface. As it does so, the weight of the pew 18 will cause the barbs 14 to penetrate the carpeted surface. The combination of the weight of the pew 18 and the angle of the barbs 14 will cause the pew 18 to resist lateral movement when a person bumps into the pew 18. Such resistance may be enhanced as additional apparatuses 10 are utilized, and by the orientation of apparatuses 10 with barbs 14 in first and second (and perhaps additional) directions.

To remove the pew 18 and/or to move it to a different location, the pew 18 is lifted until the barbs 14 are no longer penetrating the carpeted surface. At this point, the pew 18 may be positioned as desired. If the pew 18 is to be re-positioned on the carpeted surface (e.g., at a different location), it may simply be lowered over the new location, until the weight of the pew 18 causes the barbs 14 to again penetrate the carpeted surface.

While the invention has been particularly shown and described with reference to preferred embodiments thereof, it will be understood by those skilled in the art that the foregoing and other changes in form and details may be made therein without departing from the spirit and scope of the invention.

I claim:

1. A method for securing a pew to a carpeted surface comprising:
positioning at least one pew securing apparatus to an underside of at least one leg of a pew;
the pew securing apparatus comprising:
a base;
a plurality of barbs extending at an angle from the base; and
at least one opening through the base; and
lowering the pew onto a carpeted surface until the plurality of barbs penetrate the carpeted surface.

2. The method of claim 1, further comprising:
lifting the pew until the plurality of barbs no longer penetrate the carpeted surface;
moving the pew to a second location; and
lowering the pew onto the carpeted surface at the second location until the plurality of barbs penetrate the carpeted surface.

3. A method for securing a pew to a carpeted surface comprising:
positioning a first pew securing apparatus to an underside of at least one leg of a pew;
the first pew securing apparatus comprising:
a base;
a plurality of barbs extending at an angle from the base; and
at least one opening through the base;
wherein the first pew securing apparatus is secured so that the plurality of barbs extend in a first direction;
positioning a second pew securing apparatus to an underside of at least one leg of a pew;
the second pew securing apparatus comprising:
a base;
a plurality of barbs extending at an angle from the base; and
at least one opening through the base; and
wherein the second pew securing apparatus is secured so that the plurality of barbs extend in a second direction that is different from the first direction;
lowering the pew onto a carpeted surface until each of the plurality of barbs on the first pew securing apparatus and the plurality of barbs on the second pew securing apparatus penetrate the carpeted surface.

4. The method of claim 3, further comprising:
lifting the pew until each of the plurality of barbs on the first pew securing apparatus and the plurality of barbs on the second pew securing apparatus no longer penetrate the carpeted surface;
moving the pew to a second location; and
lowering the pew onto the carpeted surface at the second location until each of the plurality of barbs on the first pew securing apparatus and the plurality of barbs on the second pew securing apparatus penetrate the carpeted surface.

5. A pew securing apparatus comprising, in combination:
a base coupled to an underside of a pew; and
a plurality of barbs extending at an angle from the base.

6. The pew securing apparatus of claim 5, further comprising:
a second base coupled to an underside of the pew; and
a plurality of barbs extending at an angle from the second base.

7. The pew securing apparatus of claim 6 wherein the plurality of barbs extending at an angle from the base extend in a first direction and the plurality of barbs extending at an angle from the second base extend in a second direction.
